(19) United States
(12) Patent Application Publication
(10) Pub. No.: US 2006/0239419 A1
(43) Pub. Date: Oct. 26, 2006

(54) Selective and dynamic voicemail

(75) Inventors: Jibu Joseph, San Diego, CA (US); Hong Leng, San Diego, CA (US); Anand Desikan, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/111,047

(22) Filed: Apr. 20, 2005

(51) Int. Cl. H04M 1/64

(52) U.S. Cl. 379/67.1

(57) ABSTRACT

The present invention is directed to a system and method for providing dynamic and selective management of the voicemails on a mobile telephone in addition to the voicemail server and to establish a selective voicemail mode, such as Automatic VM mode, Manual VM mode, and Default VM mode, which provides user friendly management of specific personal greetings. The system supports an integrated voicemail notification for various VM modes and displays a unified voicemail user interface. The voicemails stored on the mobile telephone may be categorized by the personal greeting or a key number associated with the personal greeting.

### FIELD OF THE INVENTION

The present invention generally relates to the field of telecommunication systems employing mobile telephones, and particularly to a system and method for providing user selective and dynamic voicemail for users of the mobile telephones.

### BACKGROUND OF THE INVENTION

Telecommunication systems furnishing mobile telephone services employ integrated voicemail systems which provide a voicemail service, including voicemail notifications, voicemail playback, or the like, on the mobile telephone. Presently, the voicemail service for mobile telephones is provided through a digital wireless network which includes a mobile telephone switching office (MTSO) for processing wireless calls. The MTSO is communicatively connected to a voicemail server for storing messages from a calling party in the event that the user's mobile telephone is in use, or if there is a no answer condition after a predetermined number of rings. When the MTSO detects a no answer/busy condition for the user's telephone, the voicemail server plays a default greeting or a personalized greeting established by the user to the calling party and records messages if necessary.

In such voicemail services, a user of a mobile telephone (hereinafter a “mobile user”) must make a call to connect to the wireless network to hear and/or delete voicemails saved on the voicemail server. Once connected to the network, the mobile user must follow tedious steps set forth by the voicemail server in order to change or establish personal greetings. Thus, the mobile user cannot establish different personal greetings for friends, family members, and business related parties and manage voicemails without connecting to the voicemail server.

Consequently, it would be desired to provide mobile users with the ability to establish selective personal greetings for various groups of calling parties without requiring a mobile user to connect to the wireless network (e.g., via a call to the voicemail server). It would be further desired to provide a method for providing mobile users with dynamic and selective management of voicemails on the mobile telephone in addition to the voicemail server.

### SUMMARY OF THE INVENTION

Accordingly, the present invention is directed to a system and method which provides the mobile user with dynamic and selective management of voicemails on the mobile telephone in addition to the voicemail server and to establish a selective voicemail modes, such as Automatic Voicemail (VM) mode, Manual VM mode, Default VM mode, and the like, for providing user friendly management of specific personal greetings.

According to specific embodiments, the present invention provides a mobile telephone having a selective and dynamic voicemail capacity. The mobile telephone includes a memory for storing an address book and personal greetings. Each personal greeting stored in the memory may be associated with at least one calling party of which information has been stored in the address book. When a call is received, a personal greeting associated with a calling party is retrieved from the memory. The retrieved personal greeting is then played to the calling party and a voicemail is recorded to the memory. When there is no personal greeting associated with the calling party, the call may be diverted from the calling party to a voicemail server.

In one embodiment, the mobile telephone supports various dynamic choices, such as Automatic VM mode, Manual VM mode, Default VM mode and the like, to allow a user to have greater flexibility. In the Automatic VM mode, the user can select a list of calling parties from an address book saved in the memory of the mobile telephone. Thus, when there is a telephone call connection, a determination may be made whether the calling party of the telephone call is included in the list of calling parties. If the calling party of the telephone call is included in the list of calling parties, a personal greeting associated with the listing of the calling party may be played. Any voicemail left by the calling party may then be recorded. If the calling party of the telephone call is not included in the list of calling parties, the Automatic VM mode may be converted to the Default VM mode. In the Default VM mode, the call is diverted to the voicemail server via the communication network. In the Manual VM mode, the user can assign a key number for a specific personal greeting. Thus, when a telephone call connection is made, the user may press a key number to play a desired personal greeting to the calling party.

In another embodiment, the user may establish or change personal greetings without connecting to the voicemail server via the communication network. Further, the user may interrupt any operation in order to answer a call while the calling party is connected. The present invention may support an integrated voicemail notification of various VM modes and display a unified voicemail user interface. The voicemails stored in memory in the mobile telephone may be categorized by personal greeting or key number associated with the personal greeting. In this manner, personal greeting information, including which personal greeting has been played to which calling party, or the like, may be displayed via the integrated voicemail notification.

According to other specific embodiments, the present invention provides a method for providing selective and dynamic voicemail capacity for a mobile telephone. The method includes the step of recording a desired personal greeting on a memory of the mobile telephone. In one embodiment, the desired personal greeting may be associated with a list of parties who are selected from an address book for the Automatic VM mode. In another embodiment, the desired personal greeting may be associated with a key number which is input from the user for the Manual VM mode. When a telephone call is received from a calling party, an associated personal greeting of the calling party may be played. If the calling party leaves a voicemail, the voicemail may be recorded on the memory of the mobile telephone for the Automatic VM mode and the Manual VM mode.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic block diagram illustrating a mobile telephone in accordance with an exemplary embodiment of the present invention;

FIG. 2 illustrates an exemplary main screen displaying menu options of the mobile telephone in FIG. 1;

FIGS. 3A and 3B illustrate exemplary Automatic VM Mode screens for establishing a personal greeting in accordance with an exemplary embodiment of the present invention;

FIGS. 4A through 4E illustrate exemplary Manual VM Mode screens for establishing personal greetings for Manual VM Mode;

FIGS. 5A and 5B illustrate exemplary screens in accordance with an exemplary embodiment of the present invention wherein a user chooses Manual VM mode to answer a telephone call;

FIG. 6 is a flow diagram illustrating a method for providing selective and dynamic voicemail capacity in accordance with an exemplary embodiment of the present invention; and

FIGS. 7A and 7B illustrate exemplary screens displaying an integrated voicemail notification in accordance with an exemplary embodiment of the present invention.

### DETAILED DESCRIPTION OF SPECIFIC EMBODIMENTS

Reference will now be made in detail to the presently preferred embodiments of the invention, examples of which are illustrated in the accompanying drawings.

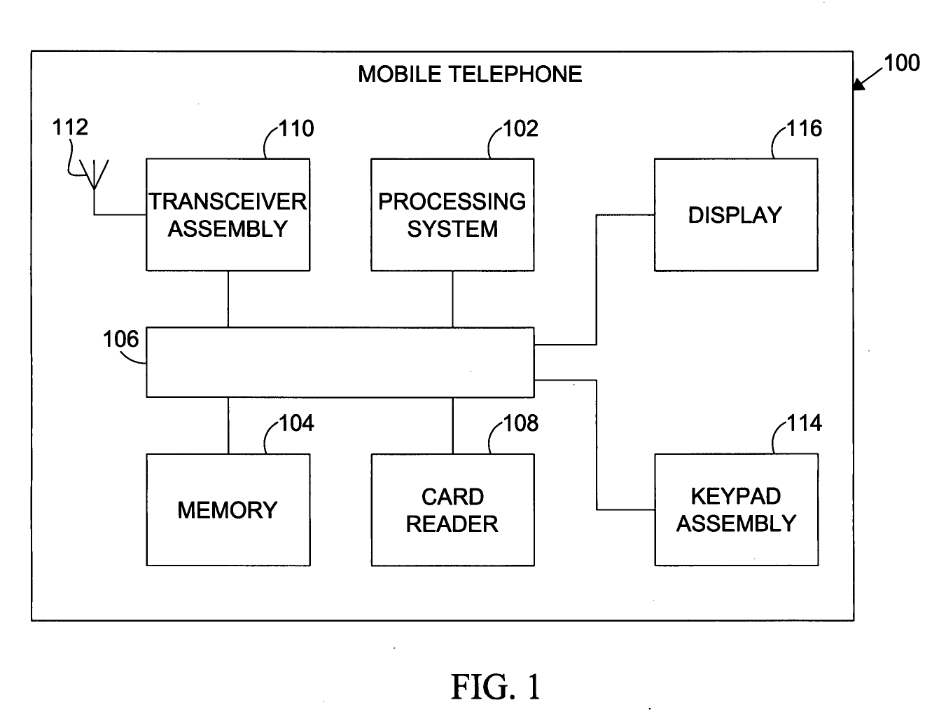

Referring to FIG. 1, a mobile telephone 100 in accordance with an exemplary embodiment of the present invention is described. The mobile telephone 100 provides wireless communication of voice and/or data information with external sources such as a base station, a cellular communication system tower, another mobile communication device, or the like. As shown in FIG. 1, the mobile telephone 100 includes a processing system 102 which controls the overall operation of the mobile telephone 100. The processing system 102 may include a general-purpose microprocessor, a digital signal processor (DSP), an application specific integrated circuit (ASIC), or the like. Exemplary processors include the Advanced RISC Machines (ARM®) microprocessor and the Intel 186 processor which are conventionally used in mobile cellular telephones.

Memory 104 is coupled to the processing system 102 (e.g., via a bus or like interface 106) for storing information including the operating system utilized by the mobile telephone 100, address books, personal greetings, and the like. The memory 104 may comprise both non-volatile and volatile storage devices. Each personal greeting may have a corresponding mail folder which stores calling party information and voicemails for the personal greeting. The processing system 102 may be configured to retrieve a personal greeting associated with the calling party from the memory, play the retrieved personal greeting to the calling party and record a voicemail to the memory. When there is no personal greeting associated with the calling party, the processing system 102 may divert a call from the calling party to a voicemail server. In various embodiments, memory 104 utilized by the mobile telephone 100 may include random access memory (RAM), read-only memory (ROM), programmable erasable ROM, flash memory, and the like.

Similarly, a data card reader 108 may be coupled to the processing system 104 via the interface 106 for receiving a removable data card providing additional memory for storing information including but not limited to telephone number information for the mobile telephone 100, address book information, security information, and the like. Exemplary data cards include subscriber identification module (SIM) cards, user identification module (UIM) cards, and the like.

A transceiver assembly 110, including a transmitter and receiver or transceiver and an antenna 112 transmit and receive data, including audio data and various other types of data such as text messaging utilized through a wireless communication system (e.g. the base station, the cellular communication system tower, another mobile communication device, or the like). The transceiver assembly 110 may further include signal conditioning circuitry (e.g., analog-to-digital converters, digital-to-analog converters), input/output buffer, and the like.

The mobile telephone 100 may further include input device such as a keypad assembly 114, or the like, for entry of alphanumeric information (e.g., telephone numbers, text messages, etc.), commands, and the like by the user. Similarly, a display 116 may be provided for displaying alphanumeric text, control menus (e.g., via a graphic user interface), prompts, and the like to the user. In exemplary embodiments, the mobile telephone 100 may further include common telephone components such as a microphone, a speaker, a ringer, a vibrator, and the like, which are not illustrated. The mobile telephone 100 supports various dynamic voicemail (VM) choices, such as Automatic VM mode, Manual VM mode, Default VM mode and the like, to allow a user to have greater flexibility.

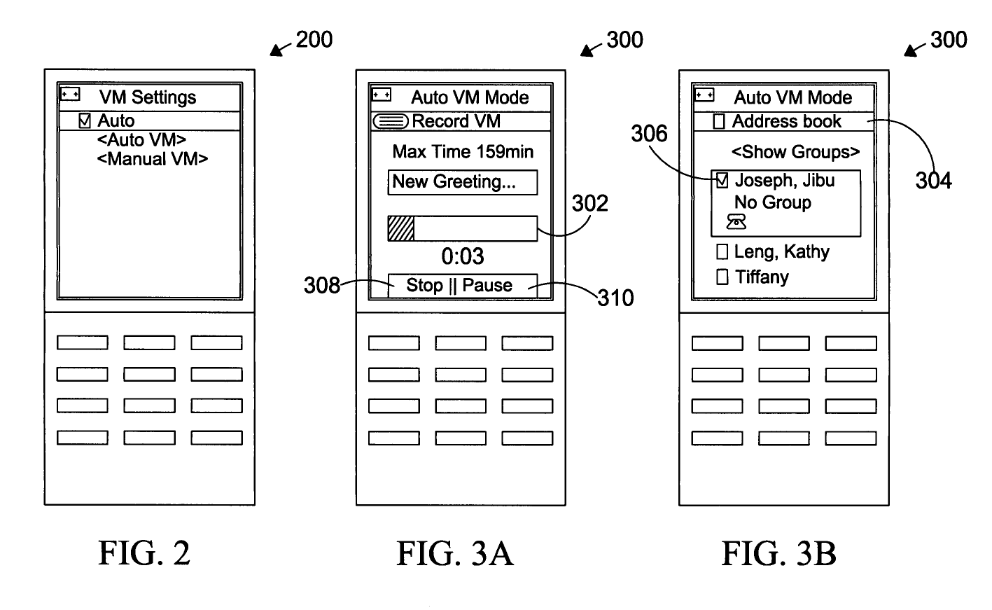

Referring now to FIG. 2, a main screen 200 for allowing a user to select a desired dynamic VM choice is depicted. In one embodiment of the invention, the main screen 200 displays a menu option for various modes (Automatic VM mode, Manual VM mode, or the like) of establishing a personal greeting for voicemails. The Automatic VM mode may allow a user to establish a personal greeting which is to be played as a response when there is a call from selected contacts. When the user desires to announce a particular message for a certain group of people, the user may select the Automatic VM mode choice from the main screen 200. The personal greeting established for the Automatic VM mode may be changed when the user records a new personal greeting. In this manner, the user may be able to announce a particular message to a group of people without answering telephone calls.

Additionally, the user may desire to have different personal greetings for various groups of people. In such a case, Manual VM mode choice 204 may be selected. The Manual VM mode may allow the user to record several personal greetings and assign a predetermined key number for each of the recorded personal greetings. Upon reception of a telephone call, the user responds to the telephone call by pressing a predetermined key number which is associated with the desired personal greeting. Then, the mobile telephone retrieves the desired personal greeting which in turn is played to the calling party.

In FIGS. 3A and 3B, the user establishes a personal greeting for the Automatic VM mode via an Automatic VM mode screen 300. The user may record a personal greeting for the Automatic VM mode. As shown in FIG. 3A, the Automatic VM mode screen 300 may display a progress bar 302 indicating the progress of recording of the personal greeting for the Automatic VM mode on the mobile telephone. The user may be able to interrupt the personal greeting recording operation and connect to the calling party by selecting Stop option 308 or Pause option 310. It is to be noted that the voice greeting data may be digitalized to be recorded (saved) on the mobile telephone. Then, the Automatic VM mode screen 300 may display a list of contacts 304 including a name, a telephone number, and the like, which are stored as an address book form on the memory of the mobile telephone as illustrated in FIG. 3B. It should be appreciated that the illustration shown in FIG. 3B is intended to be an exemplary illustration of a way to receive user selections to create a list of calling parties.

In a particular embodiment, the user may mark a check box 306 next to a contact name displayed on the Automatic VM mode screen 300. Then, the marked contact name will be included to the list of parties for the Automatic VM mode. Alternatively, every contact name in the address book may be included to a default list of parties for the Automatic VM mode. Then, the user may de-select a contact name from the default list of contact by marking the check box 306 next to the contact name displayed on the Automatic VM mode screen 300.

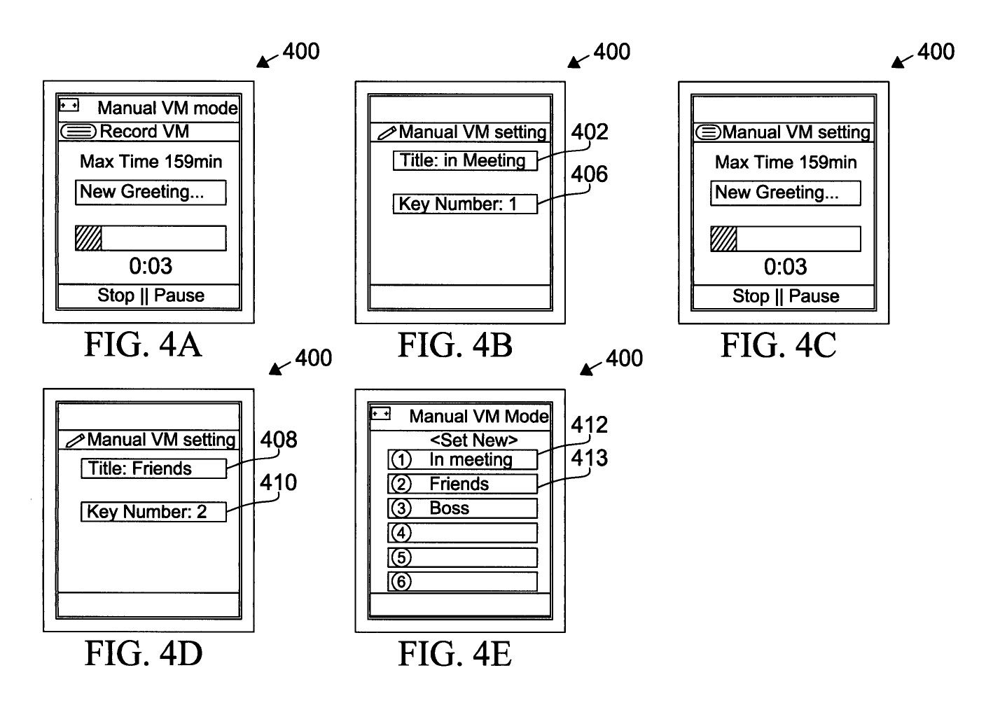

In FIGS. 4A through 4E, an exemplary Manual VM mode screen 400 is depicted. The user establishes several personal greetings for the Manual VM mode via the Manual VM mode screen 400. It should be appreciated by one of ordinary skill in the art that there are numerous ways to establish or implement the Manual VM mode without departing from the scope and spirit of the present invention. In one embodiment, the mobile telephone allows the user to play selective personal greetings by pressing an associated key number via the Manual VM mode. The user may desire to establish a selective personal greeting for a specific situation. For example, when the user is in the middle of a business meeting, the user may desire to announce “I am in a meeting with Mr. Smith so call me in 30 minutes” as a response to calls from the office but the user may desire to announce “I can not attend a Yoga class today” for calls from friends from a Yoga class. In such a situation, the user may record two different personal greetings. After recoding, the user may assign a predetermined key number to each of the recorded greetings. For example, in FIG. 4A, the user records “I am in a meeting with Mr. Smith so call me in 30 min” for a first personal greeting for the Manual VM mode. In FIG. 4B, the user enters a title of “In Meeting” 402 and its associated key number “1” 406 for the first personal greeting. In FIG. 4C, the user records “I can not attend a Yoga class today” for a second personal greeting for the Manual VM mode. In FIG. 4D, the user enters a title of “Friends” 408 and its associated key number “2” 410 for the second personal greeting.

In an alternative embodiment of the invention, the user may assign a key number and a title for a possible personal greeting to be recorded. When the user records a personal greeting, the user may assign a specific key number to the recorded greeting by entering a title associated with the specific key number. For example, the user associates “1” with “In the Meeting” title 412, “2” with “Friends” tile 413 via a menu option as shown in FIG. 4E. Later, the user records “I am in a meeting with Mr. Smith so call me in 30 minute” and then inputs “in the Meeting” for a title for the recorded personal greeting in order to assign key number “1” for the recorded personal greeting.

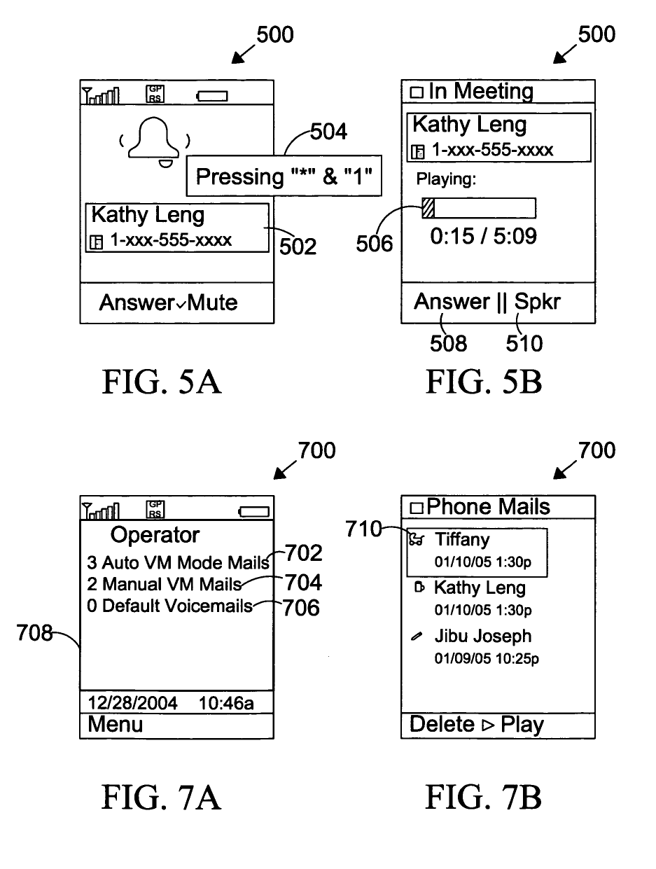

Referring now to FIGS. 5A and 5B, a calling party makes a telephone call to the mobile telephone while the user chooses the Manual VM mode. As shown in FIG. 5A, the user may be able to view a caller ID 502 of the calling party via a screen 500 of the mobile telephone. The user may input a desired key number to announce a specific personal greeting. For example, the user inputs a predetermined key number (e.g., “*” & “1”) 504 indicating that the user does not answer the call and “In the Meeting” personal greeting should be played as a response to the call. The mobile telephone may retrieve “I am in a meeting with Mr. Smith so call me in 30 minutes” personal greeting from the memory based on the inputted key number and play the personal greeting to the calling party. The calling party may leave a voicemail after the calling party has heard the “In the Meeting” personal greeting. In a preferred embodiment, the user may view the progress 506 of the Manual VM mode operation as shown in FIG. 5B. The user may be able to interrupt the Manual VM mode operation and connect to the calling party by selecting Answer option 510 or Speaker telephone option 508.

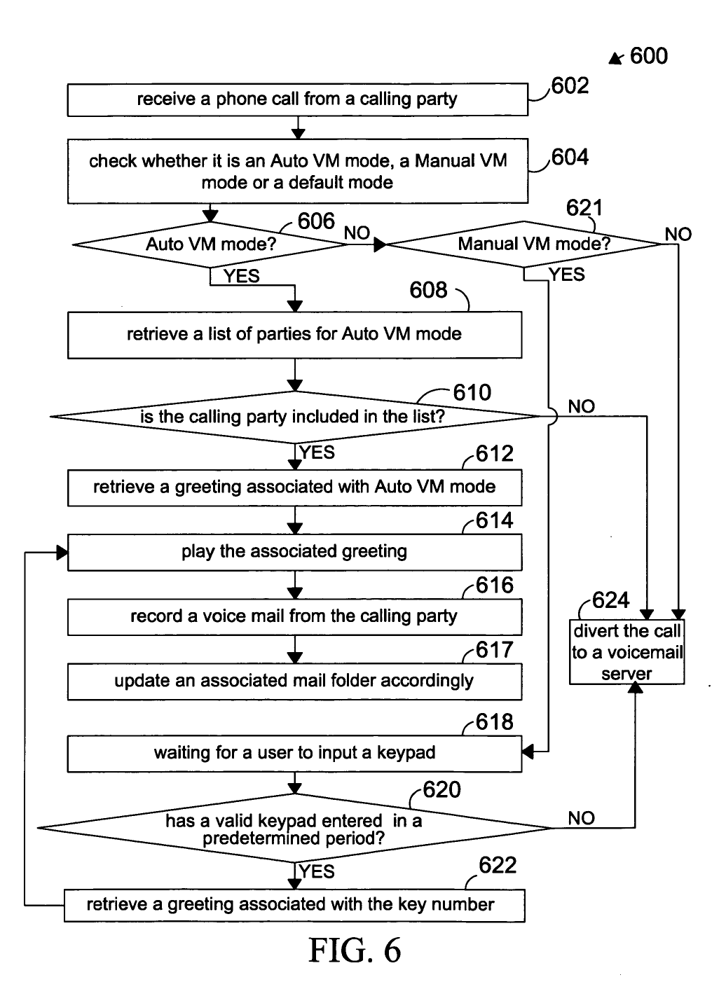

Referring now to FIG. 6, a flow diagram 600 of a method implemented in accordance with the present invention is depicted. The method begins with a step of receiving a telephone call from a calling party 602. The method may determine whether the user desires Automatic VM mode or Manual VM Mode 604. If the user desires the Automatic VM Mode 606, a list of parties for the Automatic VM mode saved in the mobile telephone may be retrieved 608. If the calling party is not included in the list of parties for the Automatic VM mode 610, the telephone call may be diverted to a voicemail server over the digital wireless network 624. The calling party may leave a voicemail which will be recorded to the voicemail server.

If the calling party is included in the list of parties for the Automatic VM mode 610, then a personal greeting associated with the Automatic VM mode may be retrieved 612. In the event that the user's mobile telephone is busy, or if there is a no answer condition after a predetermined number of rings, the retrieved personal greeting may be played to the calling party 614. The method may record a voicemail provided from the calling party to the memory in the mobile telephone 616. In one embodiment of the invention, the recorded voicemail may be categorized as an Automatic VM mode voicemail. An associated mail folder of the Automatic VM mode personal greeting may be updated accordingly 617. For example, a number of Automatic VM mode voicemails, a caller ID of the calling party, and appropriate information for a voicemail notification may be updated.

If the user desires Manual VM mode 621, the method may wait for the user to input a key number 618. Then, the method may determine whether the inputted key number is valid 620. If the inputted key number is not valid or the user has not entered any key number after a predetermined number of rings, the call from the calling party may be diverted to the voicemail server 624. If the inputted key number is valid, a personal greeting associated with the key number will be retrieved from the memory 622. Then, the retrieved personal greeting may be played to the calling party 614. The method may record a voicemail from the calling party to the memory in the mobile telephone 616. In one embodiment, the recorded voicemail may be categorized based on the key number and its associated title. An associated mail folder of the Manual VM mode personal greeting may be updated accordingly 617. For example, a number of voicemails for the particular Manual VM mode personal greeting, a caller ID of the calling party, and appropriate information for a voicemail notification may be updated. In a further embodiment, a graphic icon associated with each title for the Manual VM mode may be utilized for a user friendly voicemail notification.

Referring now to FIGS. 7A and 7B, an integrated notification of voicemails 708 is displayed on a screen 700 when there have been voicemails recorded in the mobile telephone or a voicemail server. As shown in FIG. 7A, the integrated notification of voicemails 708 may include information related to voicemails, such as the number of Automatic VM mode voicemails recorded 702, the number of Manual VM mode voicemails recorded 704, and the number of Default mode voicemails (i.e. voicemails recorded to the voicemail server) recorded 706, and the like. The user may have a choice to listen to Automatic VM mode voicemails, Manual VM mode voicemails, or Default mode voicemails.

The mobile user may desire to know which personal greeting has been played to which calling party. In one embodiment of the invention, the voicemails and caller IDs of calling parties may be categorized by a personal greeting or a key number associated with the personal greeting. Such categorized information may be stored in an associated mail folder on the mobile telephone. As such, the categorized personal greeting information, including which personal greeting has been played to which calling party, or the like, may be displayed via the integrated voicemail notification. As illustrated in FIG. 7B, a graphic icon 710 associated with each title for the Manual VM mode may be utilized for the integrated voicemail notification.

In the exemplary embodiments, the method of the present invention may be implemented as sets of instructions or software readable by the mobile telephone. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing a selective and dynamic voicemail capacity for a mobile telephone, the method comprising:
recording a personal greeting in a memory of the mobile telephone;
associating the personal greeting with a list of parties selected by a user for an automatic voicemail mode; and
associating the personal greeting with a key number for a manual voicemail mode.

2. The method as described in claim 1, further comprising:
receiving a telephone call from a calling party;
determining a desired mode for the mobile telephone;
playing an associated personal greeting of the calling party based on the desired mode and saving calling party information to a corresponding mail folder of the associated personal greeting; and
recording a voicemail left by the calling party to the corresponding mail folder;
updating information necessary for an integrated voicemail notification;
wherein each personal greeting has its corresponding mail folder on the memory of the mobile telephone.

3. The method as described in claim 2, further comprising:
upon reception of a telephone call from a calling party, receiving a key number and selecting a personal greeting based on the key number as the associated personal greeting for the calling party,
wherein the user desires the manual voicemail mode.

4. The method as described in claim 2, further comprising:
selecting a personal greeting set up for the automatic voicemail mode as the associated personal greeting for the calling party if the calling party is included in the list of parties for the automatic voicemail mode,
wherein the user desires the automatic voicemail mode.

5. The method as described in claim 1, further comprising:
displaying the integrated voicemail notification; and
allowing the user to listen voicemails and view calling party information for a selected personal greeting,
wherein information related to the voicemails and the calling party information have been saved on the mobile telephone.

6. The method as described in claim 1, wherein a menu screen displays a plurality of parties saved on an address book of the mobile telephone and allows the user to select each party from the plurality of parties for forming the list of parties for the automatic voicemail mode.

7. The method as described in claim 1, wherein a menu screen allows the user to reassign a key number to each personal greeting saved in the memory for the manual voicemail mode.

8. The method as described in claim 2, wherein when the calling party does not have any associated personal greetings saved on the mobile telephone, the call is diverted to a voicemail server on a digital wireless network.

9. A mobile telephone providing a selective and dynamic voicemail capacity, comprising:
a memory for storing an address book and a plurality of personal greetings, each of the plurality of personal greetings having a corresponding mail folder;
a display for displaying an integrated user interface;
a processing system coupled to the memory, the processing system being configured to retrieve a selective personal greeting for a calling party from the memory, play the retrieved personal greeting to the calling party and record calling party information and a voicemail left by the calling party to the memory;
a keypad coupled to the processing system, the keypad for inputting the user selections via the integrated user interface,
wherein the processing system diverts a call from the calling party to a voicemail server when no personal greeting has been selected from the memory.

10. The mobile telephone as described in claim 9, wherein for the automatic voicemail mode, a group of parties is selected by the user and an associated personal greeting of the group of parties is selected by the user.

11. The mobile telephone as described in claim 9, wherein for the manual voicemail mode, each of the personal greetings which are assigned for the manual voicemail mode has an associated key number.

12. The mobile telephone as described in claim 11, wherein upon reception of a key number, the personal greeting associated with the received key number is selected and retrieved from the memory.

13. The mobile telephone as described in claim 9, wherein an integrated voicemail notification is displayed for allowing the user to listen to voicemails and view calling party information for a selected personal greeting.

14. The mobile telephone as described in claim 13, wherein information related to the voicemails and the calling party information have been saved to a corresponding mail folder of each of the plurality of personal greetings.

15. A mobile telephone, comprising:
means for determining a desired mode for the mobile telephone upon reception of a call;
means for playing an associated personal greeting of the calling party based on the mode and saving calling party information to a corresponding mail folder of the associated personal greeting; and
means for recording a voicemail left by the calling party to the corresponding mail folder on the memory of the mobile telephone and updating information necessary for an integrated voice mail notification,
wherein the desired mode for the mobile telephone has been selected by the user.

16. The mobile telephone as described in claim 15, further comprising:
means for recording a personal greeting on memory of the mobile telephone;
means for associating the personal greeting with a list of parties selected by a user for an automatic voicemail mode; and
means for associating the personal greeting with a title of a group of parties, the title of the group of parties having an associated key number for a manual voice mode.

17. The mobile telephone as described in claim 15, further comprising:
means for receiving a key number from the user and selecting a greeting associated with the key number if the user desires the manual voice mode to answer a call.

18. The mobile telephone as described in claim 15, further comprising means for determining whether the calling party is included in the list of parties for the automatic voicemail mode and selecting a personal greeting associated with the list of parties for the associated personal greeting for the calling party if the user desires the automatic voicemail mode to answer a call.

19. The mobile telephone as described in claim 15, further comprising means for creating the list of parties for the automatic voicemail mode based on user selections.

20. The mobile telephone as described in claim 15, wherein when the calling party does not have any associated personal greetings saved on the mobile telephone, the call is diverted to a voicemail server on a digital wireless network.
